(19) United States
(12) Patent Application Publication
(10) Pub. No.: US 2020/0116187 A1
(43) Pub. Date: Apr. 16, 2020

(54) Self-Tapping Screw With Stop Flange That is Formed by Threading Die

(71) Applicant: Wei-Chih Chen, Taichung City (TW)

(72) Inventor: Wei-Chih Chen, Taichung City (TW)

(21) Appl. No.: 16/157,189

(22) Filed: Oct. 11, 2018

(51) Int. Cl. F16B 25/10; F16B 25/00

(52) U.S. Cl. CPC F16B 25/103; F16B 25/0078; F16B 25/0084

(57) ABSTRACT

A self-tapping screw includes a shank having a rear end provided with a drilling tip and an external thread. The external thread has a top formed with a stop flange. The stop flange has a diameter greater than that of the external thread. Thus, the shank is integrally formed with the stop flange by two threading dies, to stop a further movement of the external thread, and to prevent the external thread from being fed and locked excessively, thereby preventing the shank from being worn out or broken during operation.

### BACKGROUND OF THE INVENTION

### 1. Field of the Invention

The present invention relates to a screw and, more particularly, to a self-tapping screw.

### 2. Description of the Related Art

A first conventional self-tapping screw in accordance with the prior art shown in FIGS. 1 and 2 comprises a shank 10 and a headless screw 16 connected with the shank 10. The shank 10 has a front end provided with a fixing plate 11 disposed horizontally. The fixing plate 11 has a top provided with a rotation head 12 disposed vertically. The rotation head 12 is provided with a through hole 13. Thus, the rotation head 12 is rotated by a driving tool to rotate the shank 10. The shank 10 has a rear end provided with a mounting tube 14 which has an interior provided with an internal thread 15. The headless screw 16 is screwed into the internal thread 15 of the mounting tube 14 and has a rear end provided with a tip 17. A stepped face 18 is defined between the mounting tube 14 and the headless screw 16. The shank 10 and the headless screw 16 are made individually, and the headless screw 16 is then screwed into the internal thread 15 of the shank 10. However, the headless screw 16 is easily fed and locked excessively due to an undue working, an erroneous assembly process or improper operation of the user, so that the headless screw 16 is easily worn out or broken during operation.

A second conventional self-tapping screw in accordance with the prior art shown in FIGS. 3 and 4 comprises a shank 20 and a headless screw 27 connected with the shank 20. The shank 20 has a front end provided with an enlarged portion 21 which has a top provided with a fixing plate 22 disposed horizontally. The fixing plate 22 has a top provided with a rotation head 23 disposed vertically. The rotation head 23 is provided with a through hole 24. Thus, the rotation head 23 is rotated by a driving tool to rotate the shank 20. The shank 20 has a rear end provided with a mounting tube 25 which has an interior provided with an internal thread 26. The headless screw 27 is screwed into the internal thread 26 of the mounting tube 25 and has a rear end provided with a tip 28. A stepped face 29 is defined between the mounting tube 25 and the headless screw 27. The shank 20 and the headless screw 27 are made individually, and the headless screw 27 is then screwed into the internal thread 26 of the shank 20. However, the headless screw 27 is easily fed and locked excessively due to an undue working, an erroneous assembly process or improper operation of the user, so that the headless screw 27 is easily worn out or broken during operation.

### BRIEF SUMMARY OF THE INVENTION

The primary objective of the present invention is to provide a self-tapping screw with a stop flange that is formed by two threading dies or thread rolling dies.

In accordance with the present invention, there is provided a self-tapping screw comprising a shank having a rear end provided with a drilling tip and an external thread. The external thread has a top formed with a stop flange to stop a further movement of the external thread. The stop flange has a diameter greater than that of the external thread.

Preferably, the shank is provided with a groove located above the stop flange. The shank is worked by two threading dies. Each of the two threading dies is provided with an external thread forming section corresponding to the external thread of the shank. Each of the two threading dies is provided with a notch located at a top of the external thread forming section and corresponding to the stop flange of the shank. The notch includes an upper ramp and a lower ramp. The notch has a dimension decreased gradually from a starting position to a ending position thereof. The notch has a top provided with an insert. The insert has a dimension increased gradually from a starting position to a ending position thereof. The insert has a top provided with a recessed corner. The recessed corner has a flat shape. The insert and the recessed corner are inserted into the top of the external thread to form the groove in the shank, and squeeze downward an extruded portion formed during formation of the groove to form the stop flange, such that the shank is formed integrally with the external thread and the stop flange.

Preferably, each of the two threading dies is provided with an antiskid section located at a starting position of the external thread forming section.

Preferably, each of the two threading dies is provided with an opening and a plane corresponding to the drilling tip of the shank. The plane has a rear end provided with an arcuate face. The drilling tip of the shank extends into and is hidden in the opening during threading of the external thread and during squeezing of the stop flange.

Preferably, the stop flange has a bottom provided with a flat face and a top provided with a conic face.

Preferably, the shank has a front end provided with a fixing plate disposed horizontally. The fixing plate has a top provided with a rotation head disposed vertically.

Preferably, the rotation head is a sheet plate and provided with a through hole.

According to the primary advantage of the present invention, the external thread forming section of each of the two threading dies performs threading on the rotating shank, and the notch of each of the two threading dies performs squeezing on the rotating shank simultaneously, such that the shank is integrally formed with the external thread and the stop flange.

According to another advantage of the present invention, the shank is integrally formed with the stop flange, to stop and prevent the external thread from being fed and locked excessively due to an undue working, an erroneous assembly process or improper operation of the user, thereby preventing the shank from being worn out or broken during operation.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a first conventional self-tapping screw in accordance with the prior art.

FIG. 2 is a cross-sectional assembly view of the first conventional self-tapping screw in accordance with the prior art.

FIG. 3 is an exploded perspective view of a second conventional self-tapping screw in accordance with the prior art.

FIG. 4 is a cross-sectional assembly view of the second conventional self-tapping screw in accordance with the prior art.

FIG. 5 is a perspective view of a self-tapping screw in accordance with the preferred embodiment of the present invention.

FIG. 6 is a cross-sectional view of the self-tapping screw in accordance with the preferred embodiment of the present invention.

FIG. 7 is a schematic cross-sectional operational view showing a locking state of the self-tapping screw during working.

FIG. 8 is a schematic cross-sectional operational view showing a finished state of the self-tapping screw during working.

FIG. 9 is a perspective view of a threading die in accordance with the preferred embodiment of the present invention.

FIG. 10 is a front view of the threading die as shown in FIG. 9.

FIG. 11 is a cross-sectional view of the threading die taken along line “B-B” as shown in FIG. 10.

FIG. 12 is a perspective operational view showing the start state of threading of the self-tapping screw.

FIG. 13 is a plane operational view showing the start state of threading of the self-tapping screw, and a cross-sectional view taken along mark “C”.

FIG. 14 is a plane operational view showing threading of the self-tapping screw, and a cross-sectional view taken along mark “D”.

FIG. 15 is a perspective operational view showing the finished state of threading of the self-tapping screw.

FIG. 16 is a plane operational view showing the finished state of threading of the self-tapping screw, and a cross-sectional view taken along mark “E”.

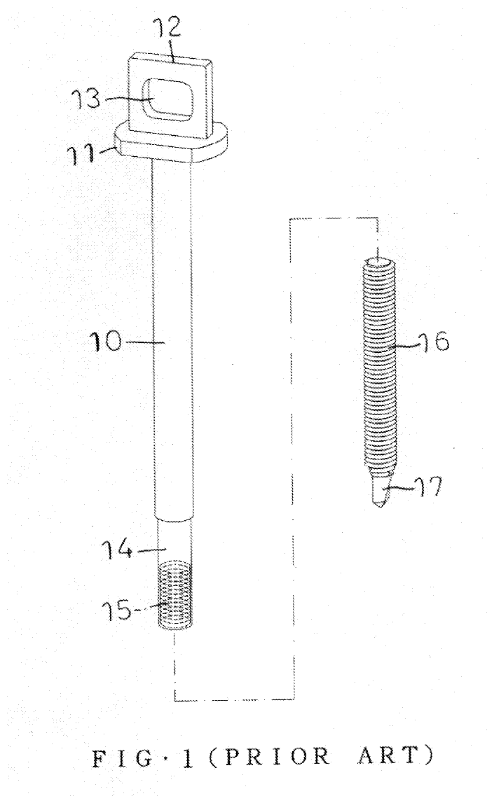

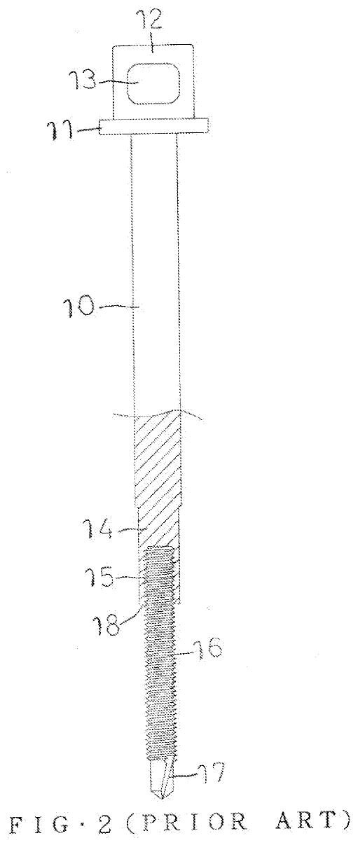

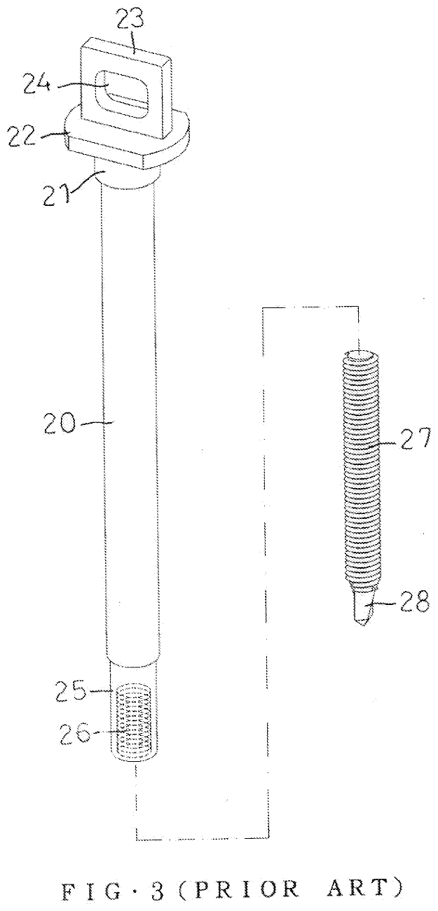

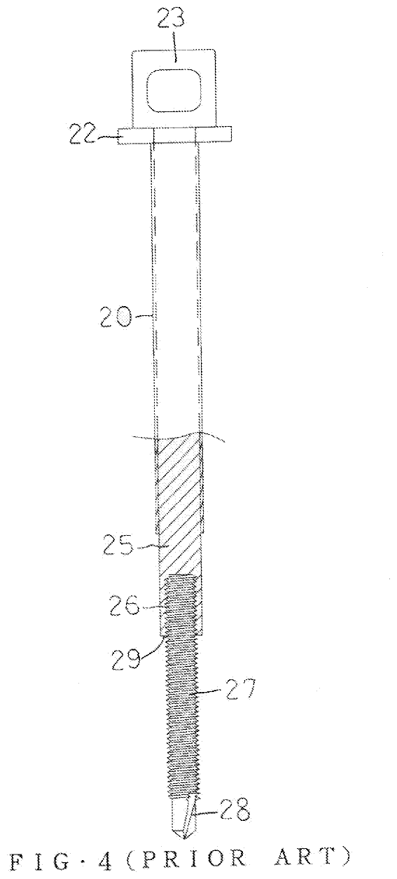

### DETAILED DESCRIPTION OF THE INVENTION

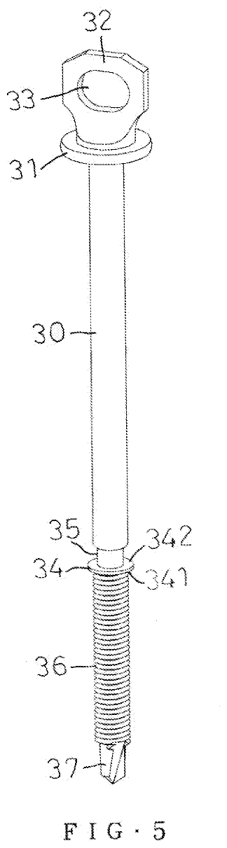

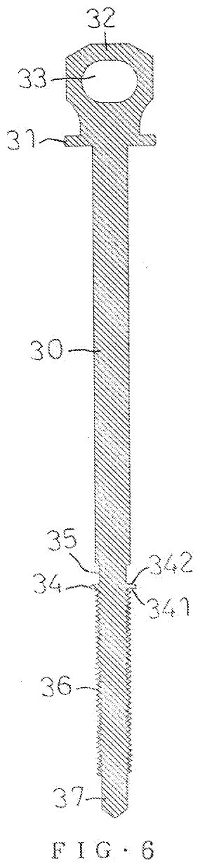

Referring to the drawings and initially to FIGS. 5 and 6, a self-tapping screw in accordance with the preferred embodiment of the present invention comprises a shank 30 having a rear end provided with a drilling tip 37 and an external thread 36. The external thread 36 has a top formed with a stop flange 34 to stop a further movement of the external thread 36. The stop flange 34 has a diameter greater than that of the external thread 36. The stop flange 34 has a bottom provided with a flat face 341 and a top provided with a conic face 342. The stop flange 34 has a position that is adjusted according to the thickness of a workpiece. The shank 30 is provided with a groove 35 located above the stop flange 34. The shank 30 has a front end provided with a fixing plate 31 disposed horizontally. The fixing plate 31 has a top provided with a rotation head 32 disposed vertically. Preferably, the rotation head 32 is a sheet plate and provided with a through hole 33. Thus, the rotation head 32 is rotated by a driving tool to rotate the shank 30.

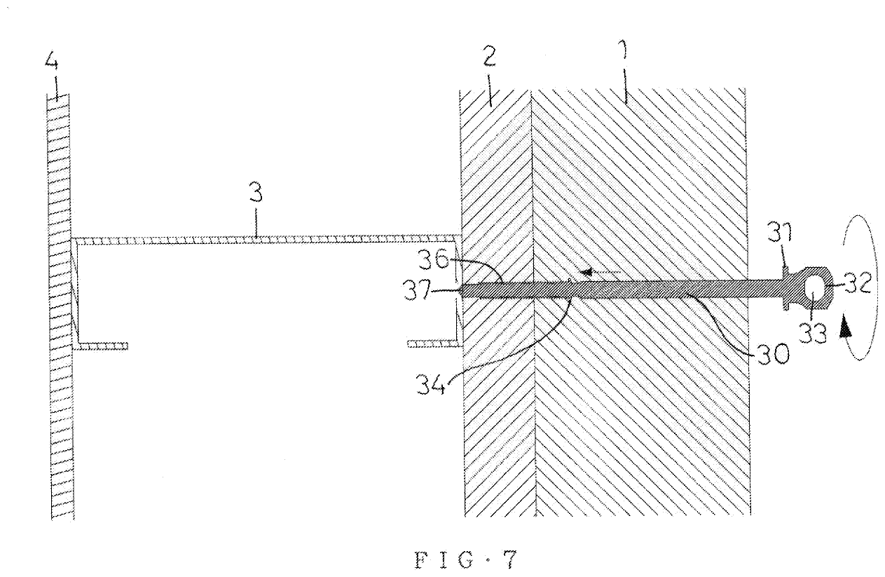

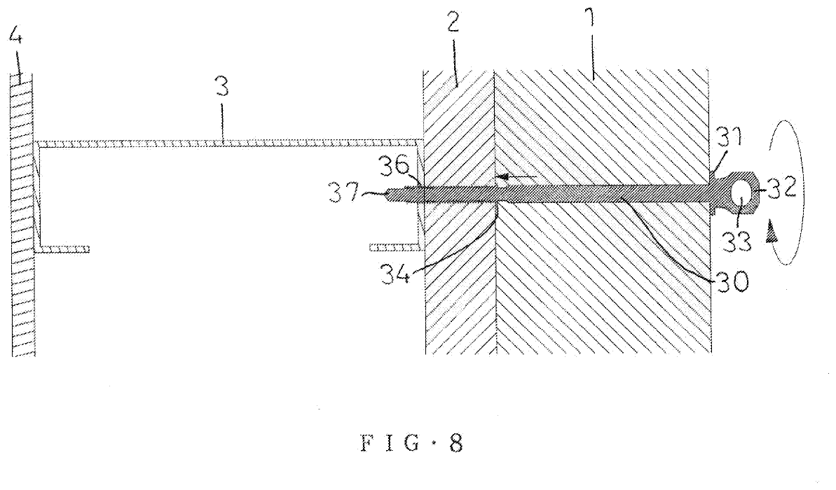

In operation, referring to FIGS. 7 and 8 with reference to FIGS. 5 and 6, a metal bracket 3 is mounted on a wall 4, an inner board 2 is mounted on the metal bracket 3, and an outer board 1 is mounted on the inner board 2. The outer board 1 has a thickness larger than that of the inner board 2. When the rotation head 32 is rotated by a driving tool, the shank 30 is rotated, such that the drilling tip 37 is driven to drill holes into the outer board 1, the inner board 2 and the metal bracket 3 as shown in FIG. 7. At the same time, the external thread 36 is screwed into the metal bracket 3. When the stop flange 34 is moved to contact the inner board 2 as shown in FIG. 8, movement of the external thread 36 is stopped, and the working is finished. At the same time, the fixing plate 31 rests on the outer board 1.

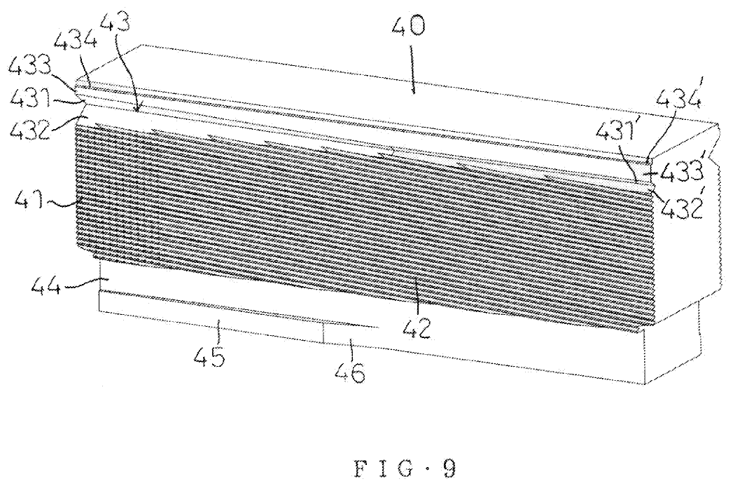

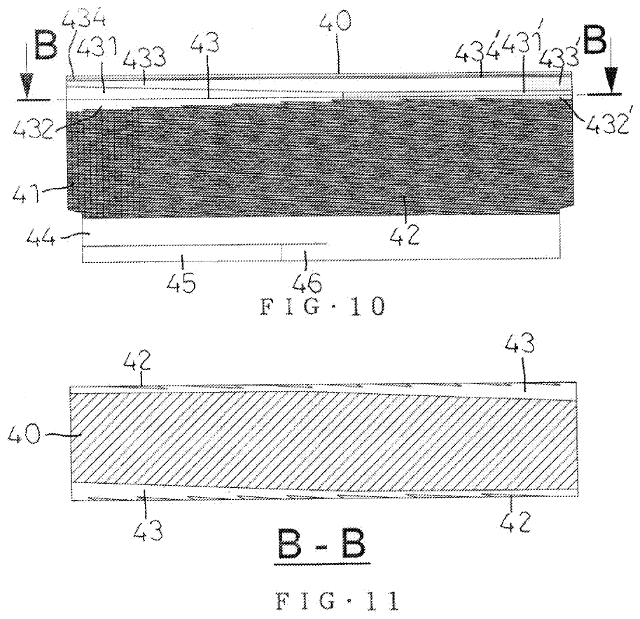

Referring to FIGS. 9-16 with reference to FIGS. 5 and 6, the shank 30 is worked by two threading dies 40. Each of the two threading dies 40 has a structure with a front face and a rear face opposite to each other. Each of the two threading dies 40 is provided with an external thread forming section 42 corresponding to the external thread 36 of the shank 30. Each of the two threading dies 40 is provided with a notch 43 located at a top of the external thread forming section 42 and corresponding to the stop flange 34 of the shank 30. The notch 43 includes an upper ramp 431 or 431′ and a lower ramp 432 or 432′. The notch 43 has a dimension (or width) decreased gradually from a starting position (at the upper ramp 431 and the lower ramp 432) to a ending position (at the upper ramp 431′ and the lower ramp 432′) thereof. The notch 43 has a top provided with an insert 433 or 433′. The insert 433 or 433′ has a dimension (or width) increased gradually from a starting position (at the insert 433) to a ending position (at the insert 433′) thereof. The insert 433 or 433′ has a top provided with a recessed corner 434 or 434′. The recessed corner 434 or 434′ has a flat shape. The insert 433 or 433′ and the recessed corner 434 or 434′ are inserted into the top of the external thread 36 to form the groove 35 in the shank 30, and squeeze downward an extruded portion formed during formation of the groove 35 to form the stop flange 34, such that the shank 30 is formed integrally with the external thread 36 and the stop flange 34. Thus, the shank 30 is squeezed during threading of the external thread 36 to integrally form the stop flange 34.

In the preferred embodiment of the present invention, each of the two threading dies 40 is provided with an antiskid section 41 located at a starting position of the external thread forming section 42.

In the preferred embodiment of the present invention, each of the two threading dies 40 is provided with an opening 44 and a plane 45 corresponding to the drilling tip 37 of the shank 30. The plane 45 has a rear end provided with an arcuate face 46. Thus, the drilling tip 37 of the shank 30 extends into and is hidden in the opening 44 during threading of the external thread 36 and during squeezing of the stop flange 34, such that the drilling tip 37 is not damaged during working of the two threading dies 40.

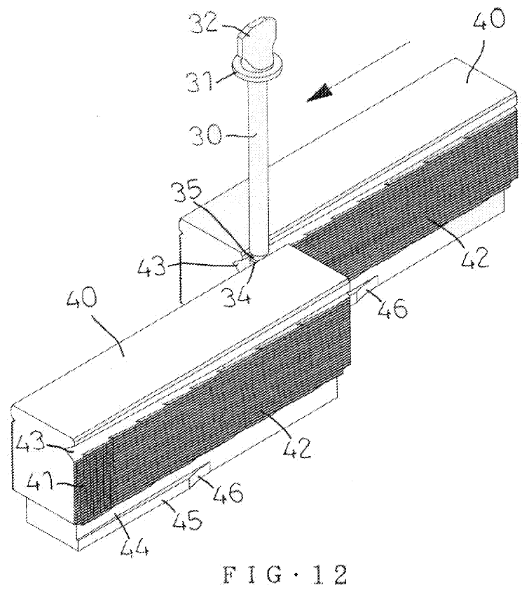

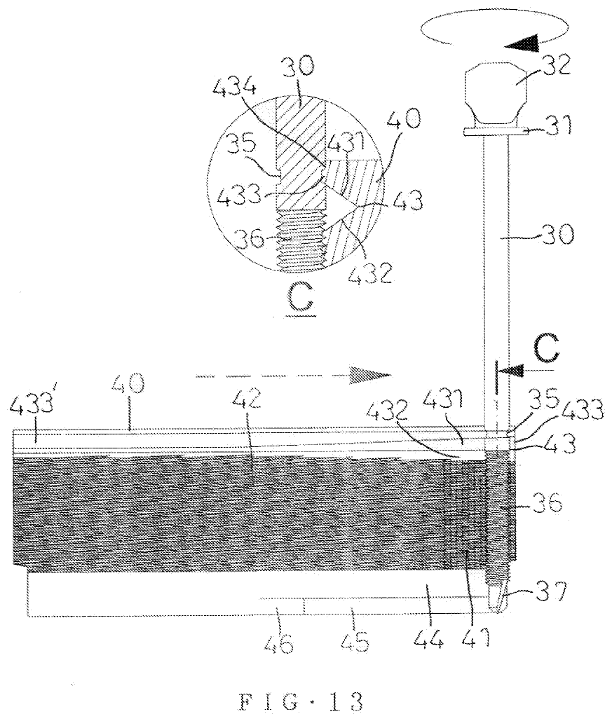

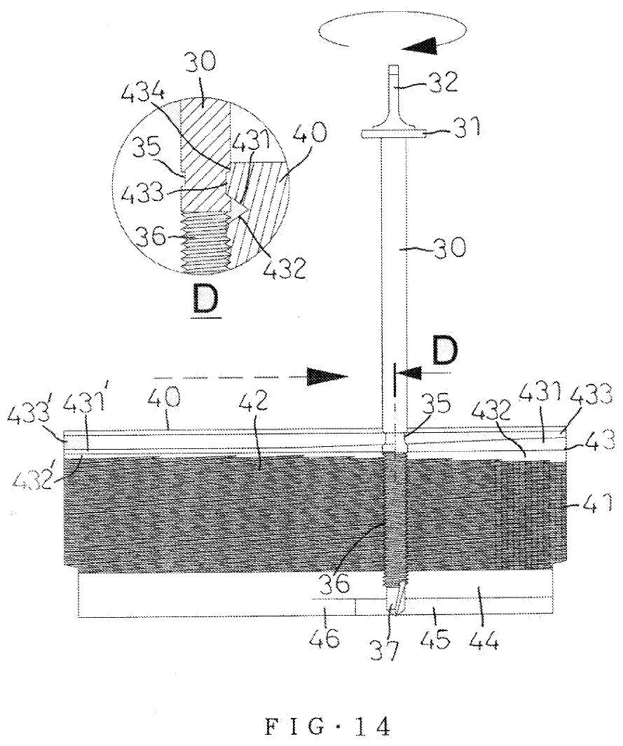

As shown in FIGS. 12 and 13, the shank 30 is sandwiched between the two threading dies 40 and located at the antiskid section 41 of each of the two threading dies 40. Then, one of the two threading dies 40 is fixed, and the other one of the two threading dies 40 is moved. In such a manner, the external thread forming section 42 of each of the two threading dies 40 performs threading and the notch 43 of each of the two threading dies 40 performs squeezing simultaneously, such that the shank 30 is integrally formed with the external thread 36 and the stop flange 34 simultaneously. At the same time, the insert 433 or 433′ and the recessed corner 434 or 434′ are inserted into the top of the external thread 36 to form the groove 35 in the shank 30.

As shown in FIG. 14, the width of the insert 433 or 433′ is increased gradually from the starting position (at the insert 433) to the ending position (at the insert 433′) thereof, such that the material for forming the groove 35 is gradually squeezed and extruded downward to form the stop flange 34. At the same time, the stop flange 34 is squeezed gradually by the upper ramp 431 or 431′ of the notch 43 to form the conic face 342 of the stop flange 34.

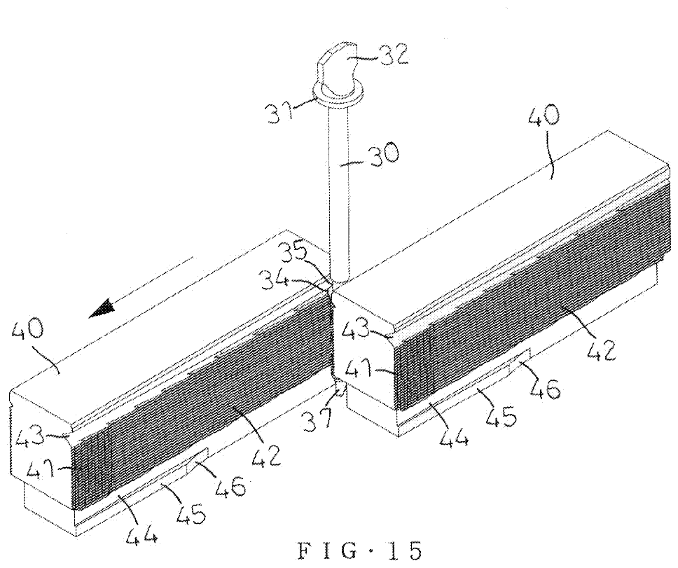

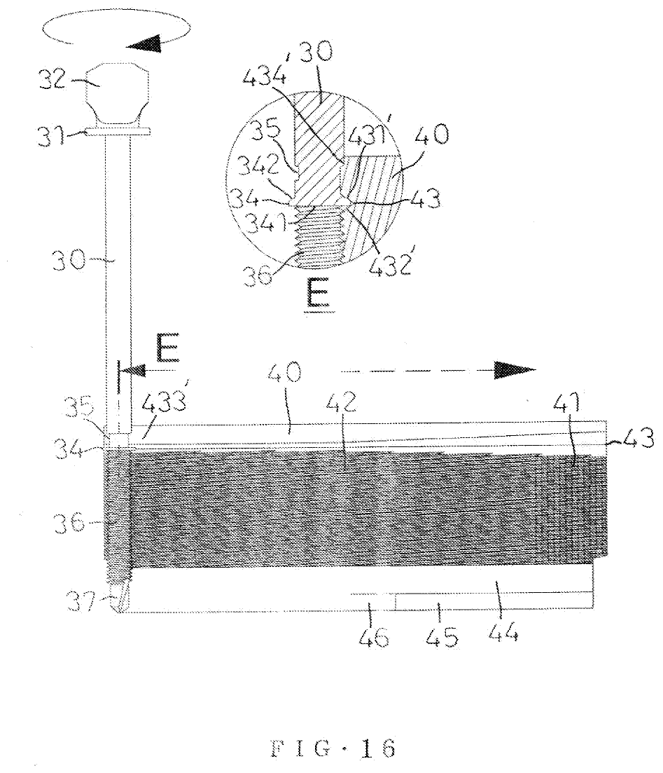

As shown in FIGS. 15 and 16, when the two threading dies 40 finish the threading work, the top of the external thread 36 is squeezed to form the stop flange 34 simultaneously, such that the shank 30 is integrally formed with the stop flange 34.

Accordingly, the external thread forming section 42 of each of the two threading dies 40 performs threading on the rotating shank 30, and the notch 43 of each of the two threading dies 40 performs squeezing on the rotating shank 30 simultaneously, such that the shank 30 is integrally formed with the external thread 36 and the stop flange 34. In addition, the shank 30 is integrally formed with the stop flange 34, to stop and prevent the external thread 36 from being fed and locked excessively due to an undue working, an erroneous assembly process or improper operation of the user, thereby preventing the shank 30 from being worn out or broken during operation.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A self-tapping screw comprising:
a shank having a rear end provided with a drilling tip and an external thread;
wherein:
the external thread has a top formed with a stop flange to stop a further movement of the external thread; and
the stop flange has a diameter greater than that of the external thread.

2. The self-tapping screw of claim 1, wherein:
the shank is provided with a groove located above the stop flange;
the shank is worked by two threading dies;
each of the two threading dies is provided with an external thread forming section corresponding to the external thread of the shank;
each of the two threading dies is provided with a notch located at a top of the external thread forming section and corresponding to the stop flange of the shank;
the notch includes an upper ramp and a lower ramp;
the notch has a dimension decreased gradually from a starting position to a ending position thereof;
the notch has a top provided with an insert;
the insert has a dimension increased gradually from a starting position to a ending position thereof;
the insert has a top provided with a recessed corner;
the recessed corner has a flat shape; and
the insert and the recessed corner are inserted into the top of the external thread to form the groove in the shank, and squeeze downward an extruded portion formed during formation of the groove to form the stop flange, such that the shank is formed integrally with the external thread and the stop flange.

3. The self-tapping screw of claim 2, wherein each of the two threading dies is provided with an antiskid section located at a starting position of the external thread forming section.

4. The self-tapping screw of claim 2, wherein:
each of the two threading dies is provided with an opening and a plane corresponding to the drilling tip of the shank;
the plane has a rear end provided with an arcuate face; and
the drilling tip of the shank extends into and is hidden in the opening during threading of the external thread and during squeezing of the stop flange.

5. The self-tapping screw of claim 1, wherein the stop flange has a bottom provided with a flat face and a top provided with a conic face.

6. The self-tapping screw of claim 1, wherein the shank has a front end provided with a fixing plate disposed horizontally, and the fixing plate has a top provided with a rotation head disposed vertically.

7. The self-tapping screw of claim 6, wherein the rotation head is a sheet plate and provided with a through hole.
